(19) United States
(12) Patent Application Publication
(10) Pub. No.: US 2017/0218285 A1
(43) Pub. Date: Aug. 3, 2017

(54) WASTE TREATMENT PROCESS FOR A FOSSIL-FUEL EXTRACTION SITE

(71) Applicant: DPS Bristol (Holdings) Limited, Portishead (GB)

(72) Inventors: David John Parkinson, Clevedon (GB); Nick Luke Palmer, Bristol (GB)

(73) Assignee: DPS Bristol (Holdings) Limited, Portishead (GB)

(21) Appl. No.: 15/502,492

(22) PCT Filed: May 12, 2015
(86) PCT No.: PCT/GB2015/051390

§ 371 Date: Feb. 7, 2017

(30) Foreign Application Priority Data
May 12, 2014 (GB) 1408315.8

(51) Int. Cl. C10J 3/66; C02F 1/66; E21B 21/06; C10B 57/04; E21B 43/20; E21B 43/34; C10B 57/10; C02F 1/463

(52) U.S. Cl. CPC C10J 3/66; C10B 57/10; C02F 1/66; C02F 1/463; C10B 57/04; E21B 43/20; E21B 43/34; E21B 21/068; E21B 21/063; C10J 2300/0906; C10J 2300/0926; C10J 2300/094; C10J 2300/1643; C02F 2103/10

(57) ABSTRACT

There is disclosed a waste treatment process for a fossil-fuel extraction site (18, 40), comprising: processing extracted waste generated by a fossil-fuel extraction process to produce primary waste having a higher calorific value than the extracted waste; mixing the primary waste with secondary waste to generate pyrolysis feedstock, the secondary waste having a lower calorific value than the primary waste; pyrolysing the pyrolysis feedstock in a pyrolysis unit (32) to form pyrolysis char; and gasifying the pyrolysis char in a gasification unit (36) to form syngas and ash.

The invention relates to a waste treatment process for a fossil-fuel extraction site.

Fossil-fuel extraction sites, such as oil wells and drilling sites for oil, natural gas and other fossil-fuel exploration are often located in remote areas, either onshore or offshore. Further, oil exploration is set to continue in challenging and remote areas such as the Arctic and Antarctic.

Aside from the extraction of fossil-fuels themselves, certain fossil-fuel extraction processes generate a waste stream, at least a portion of which contains high-calorific-value materials. For example, drilling processes require a drilling fluid to lift drilling cuttings from the drilling bore and retain the cuttings in suspension. Popular drilling fluids include oil-based drilling muds (OBMs) in which the base fluid is a petroleum product (e.g. diesel fuel), and synthetic-based fluids (SBMs) which are based on a synthetic oil. Drilling fluid and drilling cuttings are by-products that require disposal. Drilling fluid can be recycled to a degree, but it is necessary to dispose of un-recycled drilling fluids and drilling cuttings contaminated by the drilling fluid. Typical disposal methods for drilling cuttings and fluids at an offshore drilling site include discharge to the seabed, re-injection into a well and transportation ashore for disposal in land-fill. For onshore drilling sites, drilling fluid and drilling cuttings may be disposed of in land-fill. There is some concern that such disposal methods may present an environmental hazard.

Enhanced Oil Recovery (EOR) processes are a further example of a fossil-fuel extraction process which generates a waste stream containing high-calorific-value material. EOR is a process by which a greater proportion of the total oil in an oil field may be recovered by injecting fluids into the oil field. One such process is polymer flooding, in which a viscous solution of water and a polymer is injected into the oil field to drive oil towards the producing well. The fluid extracted from the producing well bore is a mixture of oil and produced water (i.e. water produced from the producing well as a by-product) comprising the polymer. The oil can be separated from the produced water. In some circumstances it is possible to separate a proportion of the produced water for reuse (i.e. re-injection into the oil field). However, the remainder of the produced water must be disposed of. Owing to the high polymer content of the produced water (typically between 200 parts per million (ppm) and 1000 ppm, or between 200 mg per kg and 1000 mg per kg), it is undesirable and/or against environmental regulations to dispose of the produced water into the sea (for offshore oil field extraction sites) or to leave it to evaporate in an evaporation pond (for onshore oil field extraction sites).

Since fossil-fuel extraction sites are often located in remote areas of the world, it can be difficult and/or expensive to dispose of these high-calorific-value materials.

It is therefore desirable to provide a process for treating extracted waste from a fossil-fuel extraction process.

According to an aspect of the invention there is provided a waste treatment process for a fossil-fuel extraction site, comprising: processing extracted waste generated by a fossil-fuel extraction process to produce primary waste having a higher calorific value than the extracted waste; mixing the primary waste with secondary waste to generate pyrolysis feedstock, the secondary waste having a lower calorific value than the primary waste; pyrolysing the pyrolysis feedstock in a pyrolysis unit to form pyrolysis char; and gasifying the pyrolysis char in a gasification unit to form syngas and ash.

The primary waste may be high-calorific-value waste and the secondary waste may be low-calorific-value waste. The primary waste may be of high-calorific-value relative to the secondary waste.

Mixing high-calorific-value waste with low-calorific-value waste allows the overall calorific value of the resultant pyrolysis feedstock to be regulated so that it may be processed in a pyrolysis and gasification process. Mixing high-calorific-value waste with low-calorific-value waste also allows low-calorific-value waste to be processed in a self-sustaining pyrolysis and gasification process, and can allow the moisture content of the pyrolysis feedstock to be regulated.

High-calorific-value waste, such as the primary waste, may have a calorific value (CV) of greater than 30 MJ/kg (megajoules per kilogram). Low-calorific-value waste, such as the secondary waste, including consumer and/or human waste, may have a calorific value of less than 20 MJ/kg, such as between 10 MJ/kg and 20 MJ/kg.

The pyrolysis feedstock may be in the form of a slurry.

Processing extracted waste may comprise drying the extracted waste. The waste treatment process may further comprise drying the primary waste and the secondary waste after mixing. Drying may be carried out in a dryer, which may be an airless dryer.

The fossil-fuel extraction process may be an oil and/or gas extraction process.

The fossil-fuel extraction process may be an enhanced oil recovery process, and the extracted waste may comprise produced water from the enhanced oil recovery process. The enhanced oil recovery process may comprise a polymer flood, and the produced water may contain a polymer. In a polymer flood, long chain polymer molecules are mixed with water to be injected into the oil field, thereby increasing the water viscosity. As a result the water/oil mobility ratio may be reduced so that the water and polymer mix is more effective in causing the oil to move towards the producing well.

The polymer content of the produced water may be between 200 parts per million (ppm) and 1000 ppm, or between 200 mg per kg and 1000 mg per kg.

The fossil fuel extraction process may produce a recovery fluid comprising oil and produced water, and the produced water may be generated as a waste product from an oil separation process in which the oil is separated from the produced water. Processing the produced water may comprise precipitating and separating solids from the produced water. The precipitation of solids from the produced water may be performed by a pH neutralisation process. Precipitating solids from the produced water may comprise an electrocoagulation process. Separation may be performed in a settling tank. Alternatively, or in addition, separation may be performed using separation apparatus comprising one or more cyclones, filters and/or centrifuges.

The fossil-fuel extraction process may be a drilling process, such as a drilling process for an oil and/or gas extraction well, and the extracted waste may comprise drilling cuttings and drilling mud. The oil and/or gas drilling process may be a drilling process for drilling a well bore (i.e. without extracting oil or gas in the process). The drilling mud may be an oil based drilling mud (OBM). OBMs offer a number of advantages over other types of drilling muds, in particular OMBs can be used to enhance penetration rates in a drilling process.

The fossil-fuel extraction process may be a drilling process generating recyclable drilling mud, and non-recyclable drilling cuttings and drilling mud, and the extracted waste may comprise the non-recyclable drilling cuttings and drilling mud. The recyclable drilling cuttings and drilling mud may be re-circulated to the drilling process.

Primary waste may comprise extracted waste from a sub-surface source that has been processed as described herein. Secondary waste may comprise waste generated from a surface source (i.e. waste that is not generated below the ground surface, but top-side). The secondary waste may have a separate source from the primary waste. The secondary waste may comprise human waste and/or consumer waste. Human waste may include sewage. Consumer waste may include product packaging, discarded consumer products and food waste.

The waste treatment process may further comprise combusting pyrolysis gas and/or syngas generated during pyrolysis and/or gasification. The waste treatment process may further comprise generating thermal energy from the combustion of pyrolysis gas and/or syngas for use on the fossil-fuel extraction site. The thermal energy may be used to generate electrical power. The thermal energy may be used to provide air conditioning by way of a heat pump, for example a Rankine Cycle compressor.

The invention may comprise any combination of features described herein, except such combinations as are mutually exclusive.

Embodiments of the invention will now be described, by way of example, with reference to the accompanying drawings, in which:

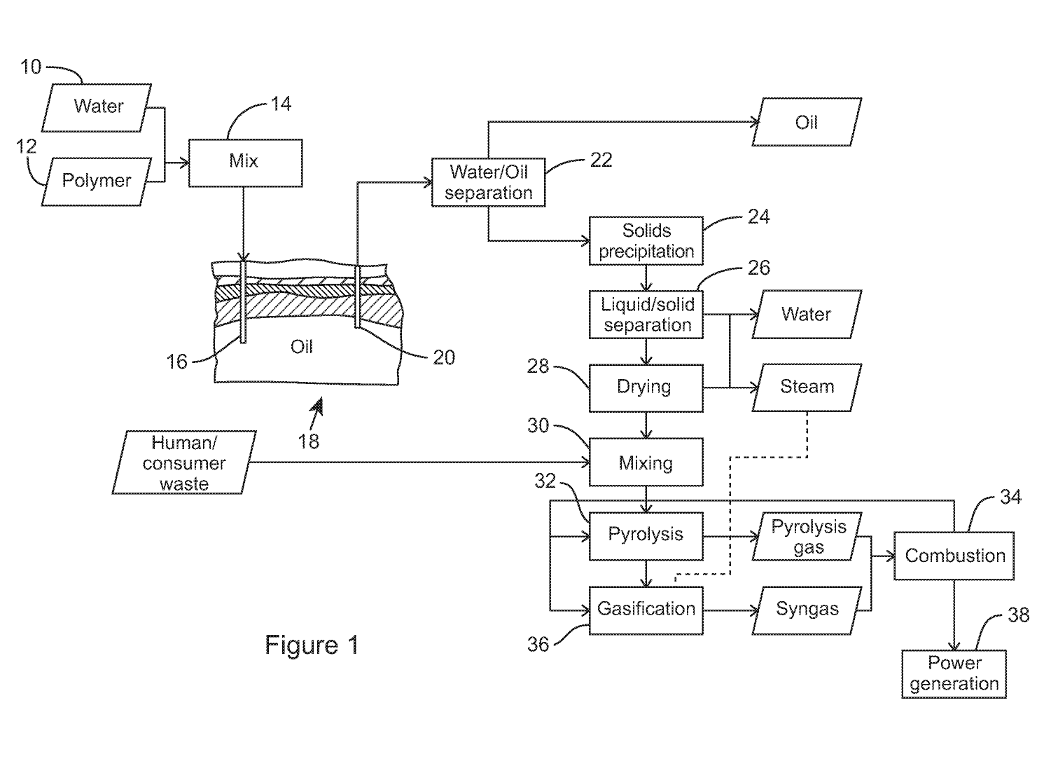

FIG. 1 schematically shows an example waste treatment process for a fossil-fuel extraction site; and

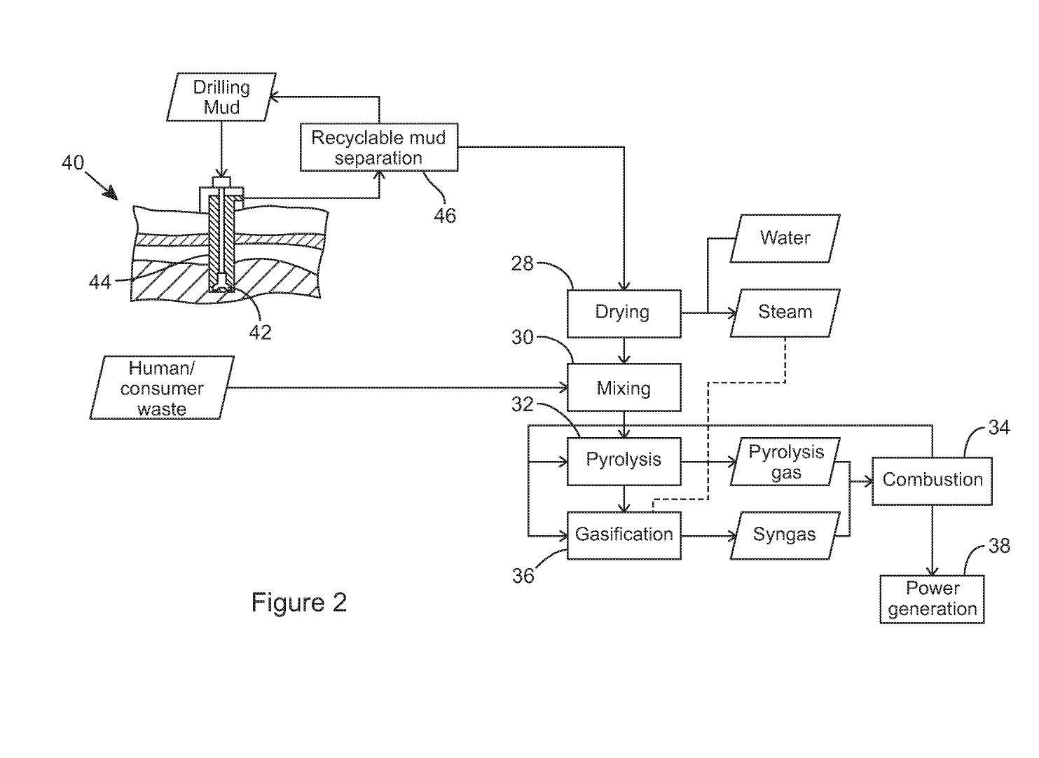

FIG. 2 schematically shows a further example waste treatment process for a fossil-fuel extraction site.

FIG. 1 shows a polymer flooding process for Enhanced Oil Recovery (EOR) from an oilfield 18, and a waste treatment process according to the invention for treating the produced water and oil from the EOR process.

In the polymer flooding process, water from a water supply 10 and polymer from a polymer supply 12 are mixed in a mixing step 14 and injected via an injection well 16 into the oil reservoir of an oil field 18. The polymer material is selected from a group of polymers having long-chain molecules which result in a high viscosity water and polymer solution. In this embodiment, the polymer is polyacrylamide “PAM” (or hydrolyzed polyacrylamide “HPAM”), but in other embodiments any suitable material may be used. In a typical Enhanced Oil Recovery (EOR) process, the polymer material makes up between 5 and 10% by weight of the solution.

The lower end of the injection well 16 is positioned within the oil reservoir of the oil field 18 so that the water and polymer solution injected into the oil field from the injection well 16 has the effect of driving oil within the reservoir to a recovery well bore 20 where it can be extracted. The high viscosity water and polymer solution is more successful in driving oil towards the recovery well bore than water alone as its increased viscosity means that it does not tend to flow through or past the oil, but rather displaces it.

A recovery fluid comprising a mixture of oil and produced water (comprising the water and polymer solution) flows up the recovery well bore 20. The recovery fluid may also contain an amount of natural gas, and a number of contaminants from the oil field 18 and/or the recovery well bore 20.

The recovery fluid is processed to separate the oil product from the produced water. In particular, the recovery fluid is transported by a pipeline from the recovery well bore 20 to an oil separator 22. In this embodiment, the oil separator 22 includes a series of three-phase separators for separating the heavy water and solids, oil, and any gas present in the recovery fluid. Three-phase separators are able to manage slug flows, in which the inlet flow comprises discrete sections of a single phase. In the three-phase separators, the heavier water and any solids within the recovery fluid fall to a low level, whereas the lighter oil rises to a higher level and forms an upper layer of oil within the separator 22. The separator 22 outputs the recovered oil through a first oil output and outputs a recovery waste stream of produced water (i.e. extracted waste consisting of the remainder of the recovery fluid) through a recovery waste output.

The recovery waste stream comprises a mixture of the water and polymer solution and any solids extracted from the oil field. The recovery waste stream is treated by separating out the water and disposing of the polymer content and contaminants, as described in detail below.

The recovery waste stream is conveyed to a solid precipitation unit 24 where the polymer content is separated out of solution with the recovery waste stream. The solid precipitation unit 24 may use any suitable solids precipitation process. In this embodiment, the solid precipitation unit 24 is a pH neutralisation unit in which the pH of the recovery waste stream is raised so that dissolved solids, including the polymer, precipitate out of the recovery waste stream. In other embodiments, different precipitation processes may be used as alternatives or in addition to pH neutralisation. An example of an alternative or additional precipitation process is electrocoagulation, in which an electrolytic cell is setup using the recovery waste stream as the electrolyte. In the electrocoagulation process, the electric charge on suspended solids in the recovery waste stream is neutralised, causing them to agglomerate together so that they may subsequently be separated from the solution.

The recovery waste stream is conveyed from the solid precipitation unit 24 to a liquid/solid separator 26, which separates the precipitated solids within the recovery waste stream from the liquids within the recovery waste stream to produce a slurry comprising the solids and a low proportion of liquid. In this embodiment the liquid/solid separator 26 comprises a plurality of hydrocyclone separators for separating the solids from the liquids, in combination with a media filter, and a centrifugal separator for treating backwash water for the media filter, such as the Hydroloc five-phase separator available from DPS Global of Portishead, UK. The centrifugal separator stratifies the waste stream into a number of radial layers under centrifugal load, with the heaviest components forming radially outer layers whilst the lighter components form radially inner layers. The centrifugal separator has a plurality of radial weirs that direct different components of the recovery waste stream to respective outlets, including a gas outlet for any natural gas, an oil outlet, a water outlet for water, and a slurry output for outputting a slurry containing a mixture of water, the precipitated polymer and any solids within the recovery waste stream. In other embodiments, the liquid/solid separator 26 may comprise a membrane filter in addition or in place of the media filter. In embodiments with smaller flow rates the liquid/solid separator 26 may comprise a centrifugal separator alone.

The slurry is conveyed from the liquid/solid separator 26 to a dryer 28. In this embodiment, the dryer 28 is an airless dryer that uses superheated steam to vaporise water from the slurry to provide a dried or partially-dried high-calorific-value stream of primary waste. The dryer 28 receives superheated steam from an onsite steam source, and outputs steam containing water vapour vaporised from the slurry which is subsequently used in the waste treatment process (see below). The primary waste output from the dryer 28 is of high-calorific-value because it contains residual hydrocarbons from the oil that is extracted by the recovery well bore 20, precipitated polymer derived from the polymer flood water, and any Volatile Organic Compounds (VOCs) such as propane and butane. Further, the primary waste has a higher calorific value than the extracted waste from the oil separator 22, at least partly due to its reduced moisture content after drying and the separation of water from the recovery waste stream.

In addition, in some embodiments the output steam flow from the dryer 28 is condensed in a condenser (not shown) to recover “light ends”, i.e. light hydrocarbons such as butane and propane LPG, that have been vaporised in the dryer 28 from the slurry.

The primary waste is conveyed from the dryer 28 to a mixer 30 where it is mixed with relatively low-calorific-value secondary waste to form pyrolysis feedstock. In this embodiment the low-calorific-value secondary waste is a mixture of human and consumer waste generated from a surface source on the fossil-fuel extraction site (i.e. a source other than a well bore).

The primary waste is mixed with the secondary waste in order to obtain a feedstock for a downstream pyrolysis and gasification process that is within an optimum calorific range such that the downstream pyrolysis and gasification process generates a sufficient quantity of pyrolysis gas and syngas to be self-sustaining, whilst the heat generated in the exothermic gasification reaction can be managed to within an optimum range, such as between 900 and 1200° C. In this embodiment, the optimum calorific range for the pyrolysis feedstock is between 20 MJ/kg and 27 MJ/kg, although in other embodiments the optimum range may be between 10 MJ/kg and 30 MJ/kg. Further, the combination of primary (high-calorific-value) and secondary (low-calorific-value) waste allows secondary waste to be disposed of on-site. For example, it may not be possible to decompose the low-calorific-value secondary waste alone using a self-sustaining pyrolysis and gasification process, and so its addition to the high-calorific-value primary waste allows it to be disposed of.

Further, the addition of secondary waste to primary waste can allow the moisture content per kilogram of the pyrolysis feedstock to be managed. For example, the secondary waste which is mixed with the primary waste can be selected to have a lower moisture content than the primary waste from the dryer 28. A moisture content of the pyrolysis feedstock of less than 20% by weight is desirable.

The pyrolysis feedstock is conveyed from the mixer 30 to a pyrolyser 32. The pyrolysis feedstock is conveyed through a pyrolysis chamber of the pyrolyser 32 which is heated to between 900° C. and 1200° C. and is sealed from external air and oxygen such that decomposition of the pyrolysis feedstock occurs under the action of thermal energy alone. As the pyrolysis feedstock decomposes in the pyrolyser 32 it forms pyrolysis char and pyrolysis gas. The pyrolysis gas is extracted from the pyrolyser 32 and delivered to a combustor 34 (see below).

The pyrolysis char is conveyed from the pyrolyser 32 to a gasifier 36. The gasifier 36 comprises a gasification chamber in which the pyrolysis char is received, and which is heated to between 900° C. and 1200° C. and supplied with steam from the dryer 28 and/or a source of oxygen, such as injected air. In some embodiments, the pyrolysis char is conveyed through the gasifier by a conveyor, such as a feed screw or flighted auger. In other embodiments, the gasifier may be an updraft or downdraft gasifier. As the pyrolysis char is gasified, syngas is produced within the gasification chamber, and the pyrolysis char decomposes to form an ash. The syngas is extracted from the gasification chamber and delivered to the combustor 34.

The pyrolysis and gasification processes decompose hydrocarbons, VOCs and other harmful products, such as PCBs (Polychlorinated Biphenyls), so that the ash output from the gasifier 36 can be safely disposed of. PCBs may originate from the low-calorific-waste, and can be safely decomposed during pyrolysis and gasification. Further, the ash output from the pyrolysis and gasification process is of significantly reduced volume and mass compared with that of the pyrolysis feedstock that is input into the process. Accordingly, the ash can be disposed of easily and safely, either on site, by transportation to landfill, or by sale for re-use.

The pyrolysis gas and syngas produced by the pyrolysis and gasification processes respectively are combusted in the combustor 34 to produce thermal energy. This thermal energy is redirected back to the pyrolyser 32 and gasifier 36 to sustain the pyrolysis and gasification processes themselves. The thermal energy may also be used to generate superheated steam for the dryer 28. Any excess thermal energy is used for power generation by a generator 38. In this embodiment, the generator 38 is a steam-cycle electricity generator. Alternatively, the generator 38 could be driven by a gas engine that runs on the pyrolysis gas and/or syngas as fuel, such as an internal combustion engine or an industrial gas turbine engine.

FIG. 2 shows a second example of a waste treatment process for a fossil-fuel extraction site. FIG. 2 shows a drilling process at a drilling site 40, and a waste treatment process according to the invention for treating the drilling mud and/or drilling cuttings generated by the drilling process.

In the drilling process, a drill bit 42 is operated to bore a well 44 and a drilling mud is injected into the well 44 to carry drilling cuttings from the base of the well 44 to the surface. In this embodiment, the drilling mud is an oil-based drilling mud (OBM) partly composed of diesel fuel. The used drilling mud and drilling cuttings received at the surface are conveyed from the well 44 to a separator 46 which separates recyclable drilling mud from non-recyclable drilling mud and drilling cuttings. The recyclable mud is returned to the well 44 for reuse.

The non-recyclable drilling cuttings and non-recyclable mud form a drilling waste (i.e. extracted waste). The drilling waste is treated before disposal as it contains and/or is contaminated with diesel fuel, and other contaminants from the drilling process, as will be described below.

The drilling waste is conveyed from the separator 46 to a dryer 28. In this embodiment, the dryer 28 is an airless dryer that uses superheated steam to vaporise water from the drilling waste to provide a dried or partially-dried primary waste stream of high-calorific-value. The dryer 28 receives superheated steam from an onsite steam source, and outputs steam containing water vapour vaporised from the drilling waste, which is subsequently used in the waste treatment process. The primary waste stream output from the dryer 28 is of high-calorific-value because it contains residual hydrocarbons from the drilling mud and cuttings, together with any Volatile Organic Compounds (VOCs) such as propane and butane used in the drilling process.

The high-calorific-value primary waste is conveyed from the dryer 28 to a mixer 30 where it is mixed with relatively low-calorific-value secondary waste to form a pyrolysis feedstock. In this embodiment the secondary waste stream is a mixture of human and consumer waste from the fossil-fuel extraction site.

The pyrolysis feedstock is processed in a self-sustaining pyrolysis and gasification process using a pyrolyser 32, a gasifier 36 and a combustor 34 as described above with reference to FIG. 1.

Where the rock formations that are being drilled are relatively porous, the cuttings can contain oil from the oil based drilling mud in its pores. It is known that this oil is difficult to remove or clean from the cuttings. However, a benefit of processing the drilling cuttings by pyrolysis and gasification is that the oil will be vaporised during pyrolysis, and the resultant pyrolysis gas and/or syngas can be oxidised and thermal energy can therefore be recovered from this oil.

Mixing high-calorific-value primary waste and low-calorific-value secondary waste as described above is beneficial at remote fossil-fuel extraction sites, as it allows the secondary waste to be decomposed by pyrolysis and gasification. For example, it may not be possible to operate a self-sustaining pyrolysis and gasification process using secondary waste alone, as such a process may produce insufficient quantities of pyrolysis gas and syngas to fuel the combustor and generate heat for the pyrolyser and/or gasifier. Further, the addition of low-calorific-value secondary waste to the high-calorific-value primary waste allows the calorific value of the pyrolysis feedstock to be managed, so as to keep the heat generated during exothermic gasification to within an optimum range (i.e. corresponding to a temperature range of between 900° C. and 1200° C.)

Further still, the separation and recycling of consumer waste on a remote site, such as an offshore platform, is typically not economically viable. It is therefore a major advantage to reduce the volume of the waste, whilst ensuring that the waste is inert (i.e. by decomposing it to form ash). The applicant has found that pyrolysis and gasification of consumer waste can reduce the volume of the waste to 12% of its original volume. Further, the inert waste may be suitable for discharge to the sea or for use in landfarming.

The pyrolysis and gasification processes may be WID-compliant (EC Directive 2000/76/EC and/or subsequent revisions). The waste treatment process may be configured so that the output of the gasification process is WAC-compliant. For example, the output may be rated “stable and non-reactive” under WAC regulations (EC decision 2003/33/EC).

Whilst embodiments of the invention have been described in which syngas is produced during gasification, it will be appreciated that the production of syngas during gasification is dependent on the pyrolysis feedstock used, and whether or not the type of feedstock will lead to methane being produced from carbon monoxide.

1. A waste treatment process comprising:
processing extracted waste generated by a fossil-fuel extraction process to produce primary waste having a higher calorific value than said extracted waste;
mixing said primary waste with secondary waste to generate pyrolysis feedstock, wherein said secondary waste has a lower calorific value than said primary waste;
pyrolysing said pyrolysis feedstock in a pyrolysis unit to form pyrolysis char; and
gasifying said pyrolysis char in a gasification unit to form syngas and ash.

2. The waste treatment process of claim 1, wherein said processing extracted waste comprises drying said extracted waste.

3. The waste treatment process of claim 1, wherein said primary waste has a calorific value of at least 30 MJ/kg.

4. The waste treatment process of claim 1, wherein said secondary waste has a calorific value less than or equal to 20 MJ/kg.

5. The waste treatment process of claim 1, wherein said fossil-fuel extraction process is selected from a group consisting of an oil extraction process and a gas extraction process.

6. The waste treatment process of claim 1, wherein said fossil-fuel extraction process is an enhanced oil recovery process, and wherein said extracted waste comprises produced water from said enhanced oil recovery process.

7. The waste treatment process of claim 6, wherein said enhanced oil recovery process comprises a polymer flood, and wherein said produced water includes polymer.

8. The waste treatment process of claim 6, wherein said fossil fuel extraction process produces a recovery fluid comprising oil and produced water, and wherein said produced water is generated as a waste product from an oil separation process.

9. The waste treatment process of claim 6, wherein processing said produced water comprises precipitating and separating solids from said produced water.

10. The waste treatment process of claim 9, wherein precipitating solids from said produced water comprises pH neutralisation.

11. The waste treatment process of claim 9, wherein precipitating solids from said produced water comprises electrocoagulation.

12. The waste treatment process of claim 1, wherein said fossil-fuel extraction process is a drilling process and said extracted waste comprises drilling cuttings and drilling mud.

13. The waste treatment process of claim 1, wherein said fossil-fuel extraction process is a drilling process generating recyclable drilling mud and non-recyclable drilling cuttings and drilling mud, and wherein said extracted waste comprises said non-recyclable drilling cuttings and drilling mud.

14. The waste treatment process of claim 1, wherein said secondary waste is selected from a group consisting of human waste and consumer waste.

15. The waste treatment process of claim 1 further comprising:
combusting syngas, wherein said syngas is selected from a group consisting of syngas generated by said pyrolysing and syngas generated by said gasifying.

16. The waste treatment process of claim 15 further comprising:
generating thermal energy from said combusting.

17. The waste treatment process of claim 16 further comprising:
generating electrical power using said thermal energy.

18. (canceled)
